(19) United States
(12) Patent Application Publication
(10) Pub. No.: US 2011/0196770 A1
(43) Pub. Date: Aug. 11, 2011

(54) System and Method for Visual and Interactive Determination of Optimal Financing and Refinancing Solutions

(75) Inventor: Peter Orr, Brooklyn, NY (US)

(73) Assignee: INTUITIVE ANALYTICS, LLC, Brooklyn, NY (US)

(21) Appl. No.: 13/025,548

(22) Filed: Feb. 11, 2011

Related U.S. Application Data
(60) Provisional application No. 61/303,582, filed on Feb. 11, 2010.
(60) Provisional application No. 61/303,514, filed on Feb. 11, 2010.

(51) Int. Cl. G06Q 40/00

(52) U.S. Cl. 705/35

(57) ABSTRACT

The present invention is directed to a system and method for optimizing liability and financial risk positions (e.g., for finance issuers), by determining, in a visual, dynamic, and interactive manner, optimal liability structures and risk exposures for finance issuers (especially in the public sector—e.g., for public finance entities managing capital market risks), given a combination of current market data, market forecasts, and financing constraints. Specifically, the various embodiments of the inventive system and method utilize optimization techniques and methodologies to create financing solutions and, at the same time, enable users to visually and interactively utilize graphical representations of one or more financing solutions, to facilitate a rapid and efficient determination and/or selection of an optimal financing solution. In at least one exemplary embodiment thereof, the inventive system and method may be readily utilized to visually, dynamically, and interactively determine optimal bond sizing, structure and refunding bond selections, for public finance issuers, given a combination of current market data, existing capital structure information, market forecasts, and financing objectives and constraints.

### CROSS REFERENCE TO RELATED APPLICATIONS

The present patent application claims priority from the commonly assigned co-pending U.S. provisional patent application, application No. 61/303,514, entitled “System and Method for Visual and Interactive Determination of Optimal Financing and Refinancing Solutions”, filed Feb. 11, 2010.

### FIELD OF THE INVENTION

The present invention relates generally to a system and method for optimizing liability and financial risk positions for finance issuers, and more particularly to data processing system and method for determining, in a visual, dynamic, and interactive manner, optimal liability structures and risk exposures for finance issuers (especially in the public sector—e.g., for public finance entities managing capital market risks), given a combination of current market data, market forecasts, and financing constraints.

### BACKGROUND OF THE INVENTION

The United States public finance industry broadly involves the raising of capital for public entities for a variety of public purposes. Public finance issuers include administrative, governmental, and municipal entities such as states, cities, counties, school districts, public housing agencies, public utilities, airport and other transportation authorities. Public finance principles also apply to not-for-profit entities like public universities, healthcare systems and hospitals, and cultural institutions like museums (hereinafter, collectively “Issuers”).

In each of the past five years, roughly $430 billion in tax-exempt securities were issued in the public finance sector. Issuers sell bonds to fund projects that are generally deemed to satisfy some public purpose such as transportation, public safety, sanitation, energy delivery, health and other social services. Usually, these bonds bear interest that is exempt from federal and state income taxes.

Due to the long useful lives of the projects financed (roads, bridges, jails, airports, hospitals, etc), these bonds have similarly long final maturities, usually 20 to 30 years, but even up to 40. A variety of considerations are involved in structuring a new financing or re-financing including availability of bank letters or lines of credit, bond insurer capacity and cost efficiency, existing debt, rating agency sensitivities, future borrowing needs, and appetite for capital market risks.

Debt service is the generic term in public finance for principal and interest payments that result from issued bonds and other debt. Ultimately, the principal amortization and resulting debt service of a bond issue is frequently determined through the use of commercially available municipal bond structuring software packages. The functionality of these products is usually limited to creating a particular aggregate or net debt service “shape” using bond structures that investors find at least somewhat attractive in the market. This amortization structure is generated based upon user defined market inputs regarding bond prices as well as other parameters such as project cost, costs of issuance, insurance, and reserve fund size.

There are many significant shortcomings of these types of widely available bond structuring software. First, they do not provide for a meaningful analysis of interest expense that varies, i.e. bonds with periodic interest rate resets (“variable rate” or “floating rate” bonds) or any of its associated forms. Specifically, the user is forced to assume a static interest rate in each period the bonds are outstanding; essentially forcing them to be calculated as fixed rate bonds. Second, they do not allow for the meaningful analysis of derivative structures which are now commonplace in public finance. Third, and as an adjunct to the first two points, no risk elements are incorporated into the solution, particularly cash flow risk which is fundamental in public finance. And last and very importantly, since the software doesn't include relevant risk measures, the net effects of natural (other on balance-sheet risks) or derivative hedges are excluded from the financial structuring solution.

Over the last decade, the use of floating rate debt has increased dramatically and along with it, the use of swaps and other derivatives. Therefore, current software products in industry do not offer the ability to meaningfully analyze these structures, not to mention assets such as cash which might provide a natural hedge for certain risks. This deficiency frequently leads to a misunderstanding of risk and ultimately, suboptimal financial decisions and liability structures.

By way of example, the functionality of existing public finance solutions are usually limited to creating a particular aggregate or net debt service “shape” based solely upon the issuer's existing debt profile and budgetary objectives. This amortization structure is generated based upon user defined market inputs regarding bond prices and coupons and the solution type.

Examples of the primary uses of funds and a brief description include the following:
Project costs—funds for construction of a project i.e. road, school, hospital, jail, etc.;
Escrow costs—funds used to purchase securities placed in escrow to retire other debt;
Underwriter's discount—funds used to compensate the underwriter for structuring and selling the bonds:
Costs of issuance—other costs of selling the debt including legal and advisory fees;
Insurance/credit enhancement—cost of insuring or otherwise enhancing the security of the bonds;
Capitalized Interest fund—An amount used to pay the first few years of interest only payments on the bonds, often prior to when the project is expected to generate revenue to support the bonds; and
Reserve fund—a reserve fund, usually exclusively pledged to bondholders, may be used to enhance the credit/security of the bonds. Often equal to a percentage of the par amount of bonds sold

The principal amortization structure is generated based upon user defined market inputs regarding bond prices as well as other parameters such as the issuer's targets for aggregate principal and interest annually over the life of the debt.

A number of standard industry solutions to bond structuring problems are shown in FIGS. 1 through 7 below. These are shown relative to a revenue estimate. For example, assume an issuer wants to structure a $100 million bond issue to be repaid over 20 years. Expected revenues to fund this debt are shown by the top line starting at $8 million and growing linearly to nearly $14 million over the next 20 years. A “level” debt service solution as shown in FIG. 1 creates equal aggregate principal and interest payments in each of the 20 years of the bond issue. A “proportional” solution as shown in FIG. 2 creates a debt service pattern which scales geometrically with the revenue constraint; in this case debt service is about 77% of the revenue constraint in each year. In FIG. 3, a “uniform” solution reflects an equal dollar difference between the revenue constraint and the annual debt service schedule. FIG. 4 shows debt service that is “accelerated” in order that it is paid off as quickly as possible within the revenue constraint. FIG. 5 shows debt service that is “deferred”; all the principal is paid in the last years of the repayment schedule. FIG. 6 reflects a “fill” solution which gives the user an answer to how much can be borrowed given debt service that completely absorbs the revenues available. In this solution, more than $100 million is raised for projects. Total revenues support a bond issue totaling more than $129 million at the prices and yields specified. FIG. 7 shows an equal principal solution which reflects an equal amount of principal in each year.

Typically, many industry professionals utilize industry-standard bond/debt service software packages such as, DBC Public Finance Software™ by SS&C Technologies, Micro-Muni™ Software from Financial Management Systems, and/or Munex™ from Ferrand Consulting Group, Inc.

However, there a number of material shortcomings of these types of widely available bond structuring software (and equivalent solutions). First, they do not provide for a meaningful analysis of interest expense that varies, i.e. bonds with periodic interest rate resets (“variable rate” or “floating rate” bonds) or any of its associated forms. Specifically, the user is forced to assume a static interest rate in each period the bonds are outstanding; essentially forcing them to be calculated as fixed rate bonds. Second, they do not allow for the analysis of non-trivial derivative structures which are now commonplace in the market. Third, and as an adjunct to the first two points, no risk elements are incorporated into the solution, particularly cash flow risk which is fundamental in public finance. Fourth, and very importantly, since the software doesn't include relevant risk measures, the net effects of natural or derivative hedges are excluded from the financial structuring solution.

At least some of the above drawbacks may be partially addressed by certain industry professionals (especially analysts in the investment banking, financial advisory, and issuer communities), who, rather than using commercially-available bond/debt service solutions software products, make a significant effort to design custom bond/debt service models for their specific needs, using spreadsheet, software and/or other data modeling/analysis tools. But such custom solutions create many of their own problems. For example, most such custom built solutions are cumbersome to use and difficult to modify or adjust, and thus many custom solutions become useful only to their creators.

Advantageously, all of the above-noted limitations and drawbacks of previously known commercially available and/or custom bond/debt service structuring solutions and techniques, are addressed and overcome by the various embodiments of a novel system and method for utilizing optimization techniques and methodologies that create liability-based financing solutions within the context of market variables modeled using stochastic techniques, shown and described in the co-pending commonly assigned U.S. patent application entitled “SYSTEM AND METHOD FOR DETERMINING OPTIMAL FINANCIAL RISK POSITIONS FOR FINANCE ISSUERS” (Application Number 13/025,514), which is hereby incorporated by reference herein in its entirety (hereinafter, the “'514 Application”).

However, there are several additional significant limitations to the above-noted widely available bond/debt service structuring software applications, and custom spreadsheet, which may not be adequately addressed by the teachings of the various embodiments of the above-incorporated '514 Application. First, despite the fact that bond/debt service structuring solutions tend to provide fairly intuitive graphical outputs (e.g., debt service graphs of various shapes), illustrating the proposed solution(s) to the problems being solved, the graphical outputs themselves are only provided as static illustrations of the results of the obtained solution(s), but are not actually used in to achieve any solution of the problem being worked on, nor to select an optimal solution from multiple options—essentially, after each solution is obtained, an analyst may generate a chart or graph in order to convey what that solution represents. This means that if a particular solution requires a that a particular debt service structure have a desirable graphical “shape” over time, the analyst must repeatedly continue to generate many different solutions, each time modifying/reconfiguring their solution application, with the hope of achieving the desired “shape” in an iterative manner (which, among other drawbacks, is a frustrating and time consuming exercise).

Second, refinancing analyses, typically referred to, in public finance, as “refundings”, require that an analyst determine and select, up-front (i.e., before any bond/debt service structure analysis can be performed), which particular bonds will be refunded as part of the solution being sought. This restrictive limitation results from the fact that currently available bond/debt service structuring applications do not permit a user to specify broader financing objectives and constraints, and is also necessary to allow the solution analytics (through not less than one optimization algorithm), to determine the bonds selected for refunding. For example, certain issuers are interested in creating overall level debt service obligations over time. As issuers fund new projects over multi-year capital plans, this goal becomes impossible to achieve, without refunding a certain portion of debt already issued. Using current bond structuring software applications and equivalent offerings, the only way to determine exactly which particular bonds must be refunded in order to achieve this objective in the most minimal cost-effective manner, is for the user to iteratively estimate what those bonds should be. The other alternative is to build a large, cumbersome, and complex spreadsheet (or equivalent) model, which may be prone to numerical errors given its custom construction. These processes are both time inefficient and prone to inaccuracy.

It would thus be desirable to provide a system and method for utilizing optimization techniques and methodologies that create financing solutions and that enable users to visually and interactively utilize graphical representations of one or more financing solutions to facilitate a rapid and efficient determination of an optimal financing solution.

### BRIEF DESCRIPTION OF THE DRAWINGS

In the drawings, wherein like reference characters denote corresponding or similar elements throughout the various figures:

FIG. 1 shows a “level” principal and interest debt service solution to a $100 million issue;

FIG. 2 shows a “proportional” principal and interest debt service solution;

FIG. 3 shows a “uniform” principal and interest debt service solution to a $100 million issue;

FIG. 4 shows an “accelerated” principal and interest debt service solution;

FIG. 5 shows a “deferred” principal and interest debt service solution to a $100 million issue;

FIG. 6 shows a “fill” proportional principal and interest debt service solution to a $100 million issue; and

FIG. 7 shows an equal principal debt service solution, which reflects an equal amount of principal in each year.

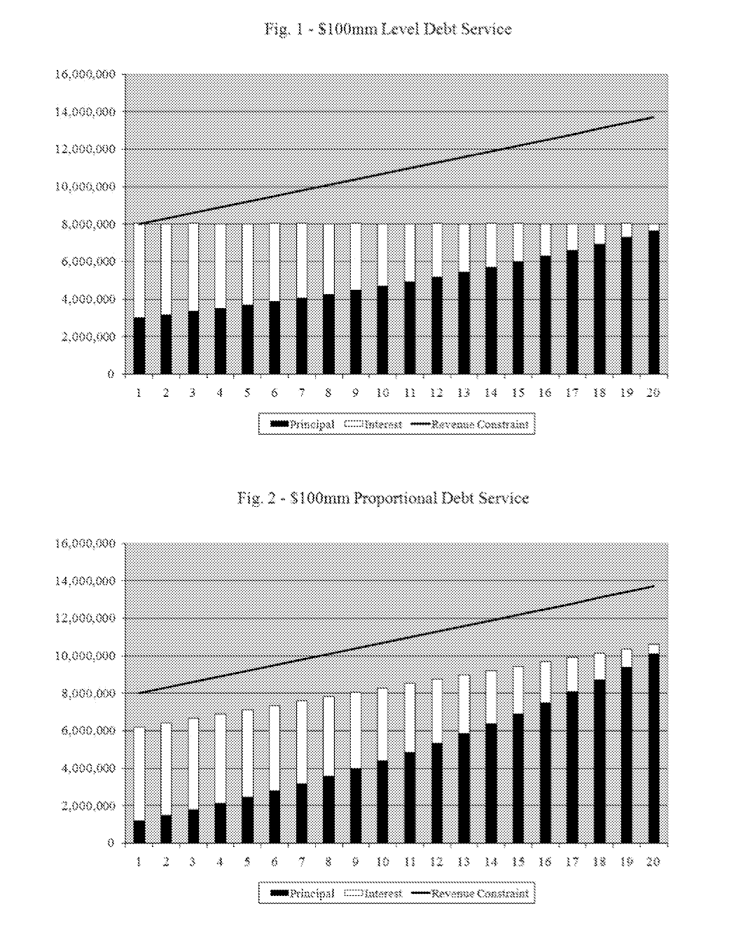

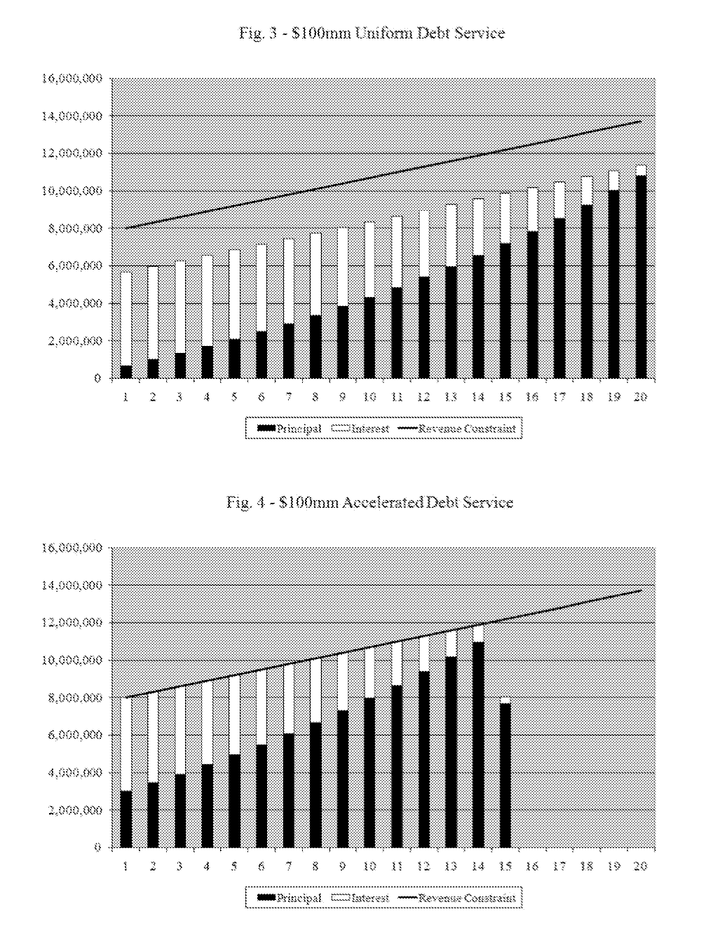

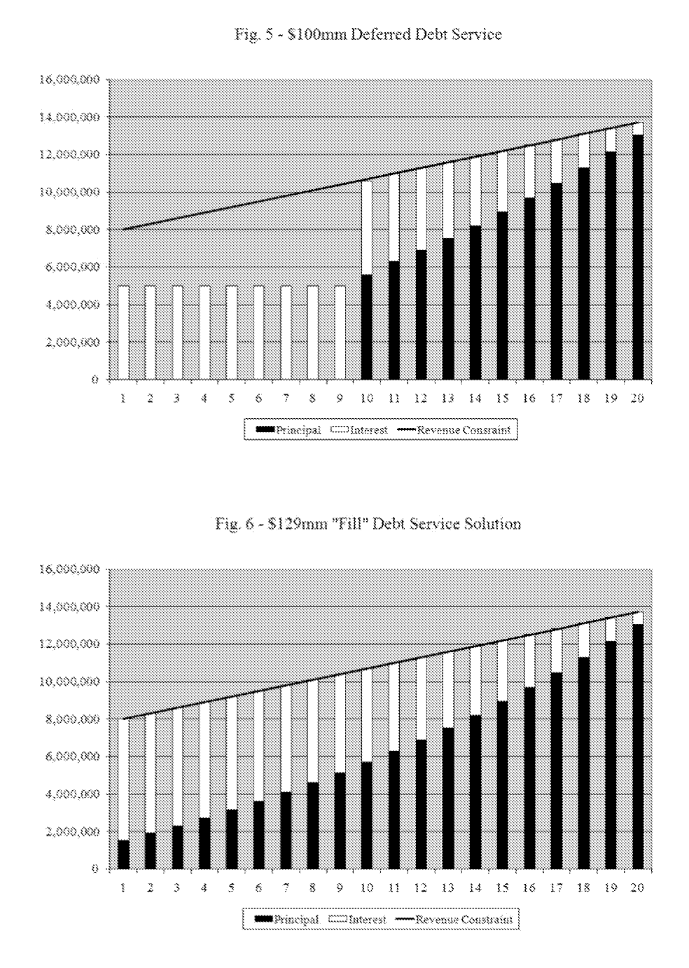

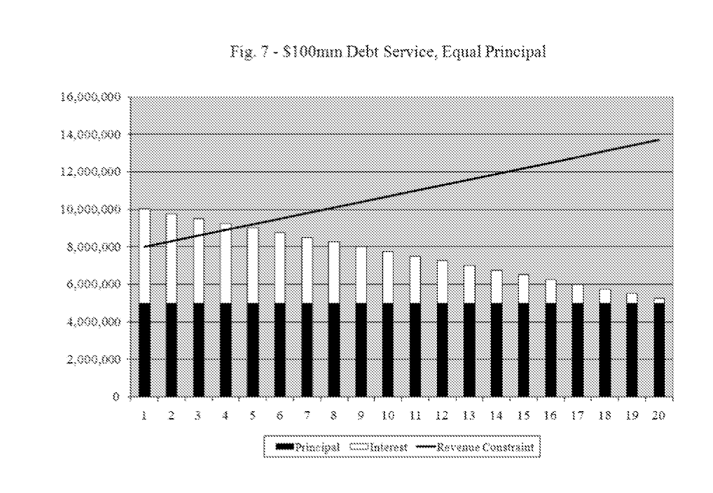

### SUMMARY OF THE INVENTION

The system and method of the present invention remedy the disadvantages of previously known systems and methods by providing optimization techniques and methodologies for utilization by finance issuers (especially those in the public finance sector), for optimizing liability and financial risk positions, by determining, in a visual, dynamic, and interactive manner, their optimal liability structures and risk exposures, given a combination of current market data, market forecasts, and financing constraints.

Advantageously, the various embodiments of the inventive system and method utilize optimization techniques and methodologies to create financing solutions and, at the same time, enable users to visually and interactively utilize graphical representations of one or more financing solutions, to facilitate a rapid and efficient determination and/or selection of an optimal financing solution.

Advantageously, in various exemplary embodiments thereof, the inventive system and method provide different novel techniques for operating at least one data processing system to optimize liability and financial risk positions (e.g., for finance issuers), by determining, in a visual, dynamic, and interactive manner, optimal liability structures and risk exposures for finance issuers (especially in the public sector—e.g., for public finance entities managing capital market risks), given a combination of current market data, market forecasts, and financing constraints. Specifically, the various embodiments of the inventive system and method utilize optimization techniques and methodologies to create financing solutions and, at the same time, enable users to visually and interactively utilize graphical representations of one or more financing solutions, to facilitate a rapid and efficient determination and/or selection of an optimal financing solution. In at least one exemplary embodiment thereof, the inventive system and method may be readily utilized to visually, dynamically, and interactively determine optimal bond sizing, structure and refunding bond selections, for public finance issuers, given a combination of current market data, existing capital structure information, market forecasts, and financing objectives and constraints.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of previously known systems and methods by providing optimization techniques and methodologies for utilization by finance issuers (especially those in the public finance sector), for optimizing liability and financial risk positions, by determining, in a visual, dynamic, and interactive manner, their optimal liability structures and risk exposures, given a combination of current market data, market forecasts, and financing constraints.

Advantageously, the various embodiments of the inventive system and method utilize optimization techniques and methodologies to create financing solutions and, at the same time, enable users to visually and interactively utilize graphical representations of one or more financing solutions, to facilitate a rapid and efficient determination and/or selection of an optimal financing solution.

It should be noted, that while the various exemplary embodiments of the inventive system and method are described with reference to public finance issuers and related applications, as well as to bonds and other debt service structures, the novel and advantageous inventive principles and techniques disclosed herein, can be readily configured, adapted, and/or applied, to solve similar problems and challenges in other financial sectors, without departing from the spirit of the present invention.

The inventive system and method can be used very broadly for those involved in issuing debt in the capital markets, particularly those in public finance. Also, inventive system and method can be incorporated into existing software technology utilized in the appropriate financial sectors (for example, such as RiskMetrics or DBC Finance) to add much-needed functionality and intuition both to risk management analyses, and new financing structures. Other parties that would readily benefit from utilizing the inventive system and method, include, but are not limited to, financial software providers particularly those serving the public finance community, rating agencies, professional investors, investment banks, financial advisors, and public finance issuers.

The present invention combines a user-interface whereby an interactive graphical representation of the financial problem is used to achieve the solution. This process may include optimally solving for bonds to be refinanced (“refunded”) as part of a comprehensive, overall financing strategy. Benefits of the present invention include reduced time to solution, increased accuracy, an enhanced understanding of the trade-offs involved in bond structure optimization, and a dramatic increase in usability

In one implementation of the present invention, loaded into memory during operation are several software components, which are both standard in the art and special to the invention. These software components collectively cause the computer system to function according to the methods of this invention. These software components are typically stored on mass storage. An operating system can be, for example without limitation, of the Microsoft Windows™ family.

Many high or low level computer languages can be used to program the analytic methods of this invention. Instructions can be interpreted during run-time or compiled. Preferred languages include, but are not limited to, C/C++, and JAVA™. In the preferred embodiment, the methods of the present invention are programmed in mathematical software packages, which allow symbolic entry of equations and high-level specification of processing, including algorithms to be used, thereby freeing a user of the need to procedurally program individual equations or algorithms. Such packages include, without limitation, the MATLAB™ computer program manufactured by The Mathworks, Inc. (Natick, Mass.), the Mathematica™ computer program manufactured by Wolfram Research, Inc. (Champaign, Ill.), or the computer program manufactured by S-Plus™ from Mathsoft Engineering & Education, Inc. (Cambridge, Mass.) Some of these packages also allow for rapid development of custom user interfaces such as the Graphical User Interface Design Environment (GUIDE) found within MATLAB™.

It is contemplated that in light of the teachings of the present invention a graphical user interface (GUI) (not shown) may be implemented by those skilled in the art in a multiplicity of suitable forms depending upon the needs of the particular application. For example, without limitation, in some embodiments, it may be Internet based or implemented in a spreadsheet program such as the Excel™ computer program manufactured by Microsoft Corporation (Seattle, Wash.). In other embodiments, a stand-alone GUI could also be created in accordance with known techniques to effect convenient user input/output. However, depending upon the requirements of a particular application, some embodiments of the present invention may not include a GUI; for example, without limitation, some embodiments of the present invention may be configured to directly interact with other software applications through a standard or custom application programmers interface (API).

A primary objective of a bond solution is to match the new debt service schedule to a revenue line in one of the several ways as described in the Background section. In at least one exemplary embodiment of the present invention, a visual representation of the revenue amounts and debt service schedule facilitates user interaction with the problem directly, dramatically accelerating the often iterative process involved in achieving various alternatives. This visual problem statement also enables those unfamiliar with the complexities of fixed income mathematics to become effective bond structuring analysts. This dramatic increase in accessibility is a major benefit of the invention.

In at least one exemplary embodiment of the present invention, each point on the revenue line may be manipulated by the user in order to facilitate rapid scenario generation. In a modification of this feature, interpolation methods may be used to provide for the movement of multiple points from a single movement of an interface device such as mouse or finger on a touch activated screen. Optionally, each point on the revenue line may be manipulated by the user in order to facilitate rapid scenario generation.

In at least one exemplary alternate embodiment of the present invention, the GUI may allow the user to select the graphical representation of each component of a financing program and customize each one individually before selecting the visualization of total debt service. Optionally, the novel GUI may allow the user to visually identify the refunded bonds debt service as a separate selection within the GUI or highlighted in some fashion in other graphic (e.g., reflecting the total debt service).

In a first preferred exemplary embodiment of the invention, and in the case of the inventive system and method being utilized to address a refunding problem, the optimization solves for the bonds to be refunded ultimately satisfying the overall objectives and constraints of the problem. In order to implement this feature, additional decision variables are added to the optimization problem. The amount of each bond maturity to be refunded is represented by a decision variable. The debt service associated with the refunded amounts from these variables is subtracted from existing debt service.

This determines remaining debt service prior to any new bond issuance. The refunded amounts are also used to calculate the cost of retiring the debt. This is usually determined by the escrow e debt service remaining (after refunding) and the cost of the refunding, affecting the “revenue” available for matching the new debt service to a revenue line.

Furthermore, the preferred embodiment of the present invention may readily comprise, but is not limited to, at least one of the following features/functionalities:
a GUI that enables the user to highlight a region of the graph and lock a portion of the solution before re-solving. This e the user to progressively arrive at a solution in stages, facilitating a more customized result.
a table reflecting revenue line values dynamically updates as the user manipulates values on the revenue line.
an interest rate model that may be used in order to calculate a distribution of debt service payments. As such, the visual representation of debt service may add a line indicating debt service at a certain confident level e.g. 95% worst case debt service.
an export module that enables the user to export calculated solutions into reports or other standard business software such as spreadsheets or word processing.
a data processing feature that enables the data used for the analysis and GUI to be supplied by a database stored on, or distributed throughout, an intranet or internet (cloud) server, or that is otherwise optimized for utilization in connection with parallel and/or distributed computing solutions.
a feature that enables the GUI is available to users on mobile computing devices, enabling advanced structuring analytics anywhere a user has access to such a device and a live network.
an interface feature that enables the user to see certain “dashboard” bond issue statistics dynamically update upon each successive calculation, etc.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method for determining at least one optimum financial liability structure, based on a plurality of financial data inputs, at least one financial factor, and at least one predefined constraint, comprising the step of:
(a) enabling a users to visually and interactively utilize graphical representations of one or more financing solutions, to facilitate a rapid and efficient determination and/or selection of an optimal financing solution.
